(19) United States
(12) Patent Application Publication
(10) Pub. No.: US 2026/0214111 A1
(43) Pub. Date: Jul. 23, 2026

(54) SYSTEMS AND METHODS FOR SECURITY ANALYSIS OF SINGLE SIGN-ON PROCESSES

(71) Applicant: Wells Fargo Bank, N.A., San Francisco, CA (US)

(72) Inventors: Puneet Rathore, Bangalore (IN); Sajeev Philip, New Delhi (IN)

(21) Appl. No.: 19/033,260

(22) Filed: Jan. 21, 2025

(51) Int. Cl. H04L 9/40; G06N 20/00

(52) U.S. Cl. CPC H04L 63/1425; G06N 20/00; H04L 63/0815

(57) ABSTRACT

Systems and methods are disclosed herein for security analysis of a single sign-on (SSO) process. An example method includes detecting a login event initiated by a user device using SSO credentials, and detecting a transaction comprising the SSO credentials involving a third-party service. The example method further includes receiving a first SSO log of user activity from a first SSO provider, and annotating the first SSO log based on the detected transaction to produce an annotated log. The example method also includes determining, using a first machine learning model, an indication of high-risk activity based on the annotated log. The example method also includes generating a first prompt based on the annotated log and the indication of high-risk activity, and generating, using a first language model, a language-based explanation of the high-risk activity.

### BACKGROUND

Single sign-on allows a user to access multiple secure resources using a single authentication process and set of login credentials. Providing a central interface for authentication may improve the user experience while improving security.

### BRIEF SUMMARY

Single sign-on (SSO) improves the user experience by allowing the use of multiple applications across multiple platforms using a single login and password combination. SSO systems provide a token to the user upon successful authentication, which is signed and potentially encrypted using a cryptographic key. The token may be made available to multiple applications throughout the token's lifetime, potentially exposing to multiple security risks.

Example embodiments disclosed herein include an artificial intelligence (AI) or machine learning (ML) model that may analyze the pathways of tokens from SSO systems to determine the level of risk to which a token is exposed. An agent may track access to the token that is provided to various entities on the client side. The collected data may be analyzed to determine the token path, which in turn is provided to an AI model. The AI model may then classify the token path to determine a risk profile and/or detect anomalous behavior. A language model may subsequently use the output of the analysis to create a natural language explanation of the anomalous behavior, including any high-risk activity detected related to the SSO session.

The AI analysis of cryptographic key pathway may be performed by an application that includes a data collection agent and a classifier model. The application may run in the background on selected client devices for data collection and security analysis purposes. For example, workstation devices for employees of an organization may include a data collection agent to report collected data back to a server for the classifier model to analyze. The data collection agent may be deployed as an active security measure, constantly monitoring token activity during SSO access to provide real-time security alerts.

The data collection agent may be integrated into a client browser or other web application that facilitates the SSO login. The data collection agent may monitor a ticket associated with an active directory for the token, determining every application that has accessed the token and the details of each access event. Collected data may be packaged and transmitted to a sever for analysis or analyzed locally using the AI model.

The AI model may receive the token path dataset and perform various analysis tasks. For example, the AI model may detect situations that are associated with high-risk security situations and act as an early warning system. The AI model may classify token paths to quantify the risk associated with certain paths and certain combinations of SSO applications. The AI model may also select token path datasets for further study by classifying high-risk datasets to collect a subset of token path instances for expert review.

Accordingly, the present disclosure sets forth systems, methods, and apparatuses that provide security analysis of SSO processes. In contrast to previous approaches, example embodiments disclosed herein provide a cohesive, automated system that uses ML to analyze logs coming from a variety of disparate sources. Example embodiments also combine logging from remote sources (e.g., SSO login services, identity providers, service providers) and cross-correlate the logs with locally collected logs (e.g., from monitoring and security agents) to prepare a cross-referenced log leading to improved confidence in detection of SSO anomalies.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for security analysis of an SSO process in accordance with some example embodiments described herein.

FIG. 2 illustrates a schematic block diagram of example circuitry embodying a SSO security analysis system that may perform various operations in accordance with some example embodiments described herein.

FIG. 3 illustrates an example flowchart for security analysis of an SSO process, in accordance with some example embodiments described herein.

FIG. 4A, FIG. 4B, and FIG. 4C illustrate additional example flowcharts for security analysis of an SSO process, in accordance with some example embodiments described herein.

FIG. 5A and FIG. 5B illustrate additional example flowcharts for security analysis of an SSO process, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

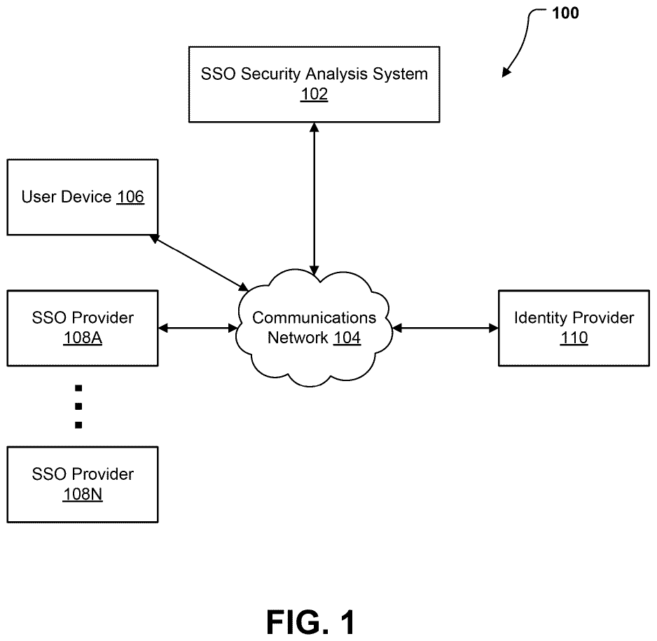

Example embodiments described herein may be implemented using any of a variety of computing devices or servers. To this end, FIG. 1 illustrates an example environment 100 within which various embodiments may operate. As illustrated, a SSO security analysis system 102 may receive and/or transmit information via communications network 104 (e.g., the Internet) with any number of other devices, such as user device 106.

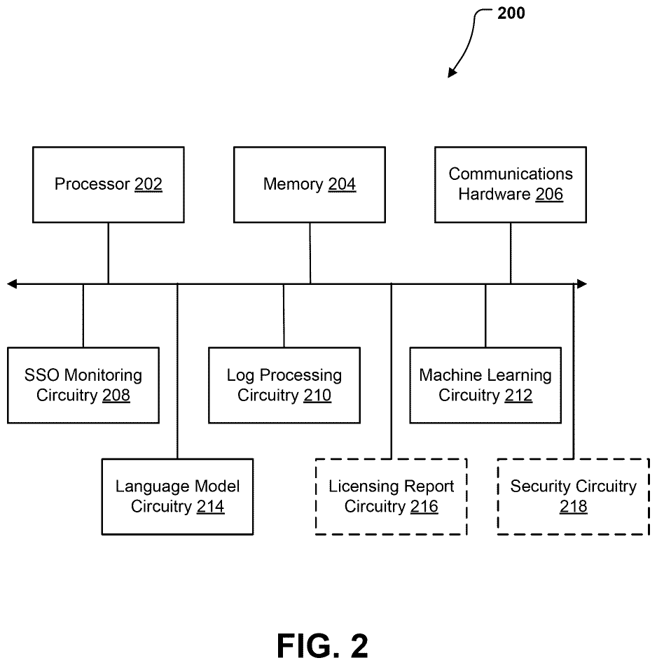

The SSO security analysis system 102 may be implemented as one or more computing devices or servers, which may be composed of a series of components. Particular components of the SSO security analysis system 102 are described in greater detail below with reference to apparatus 200 in connection with FIG. 2.

The user device 106 may be embodied by any computing devices known in the art. The user device 106 need not be an independent device but may be embodied as one or more peripheral devices communicatively coupled to other computing devices.

The SSO provider 108A through SSO provider 108N, also known as a service provider (SP) may likewise be embodied by any computing devices known in the art. SSO provider 108A-108N may exist as a cloud service or other service provided by one or more physical computing devices operating together to prove the SSO provider 108A-108N services. The SSO provider 108A-108N may provide an application or other service desired by a user that makes use of an SSO login. The SSO provider 108A-108N may rely on, for example, identity provider 110 to authenticate and authorize a user. In some embodiments, the SSO provider 108A-108N may be configured to provide a variety of functionalities in support of SSO services without relying on an external identity provider 110. In some embodiments, these functionalities may include an identity provider (IdP, which may additionally or alternatively be provided by a dedicated identity provider 110, discussed below), service provider integration, user interfaces, and implementation of protocols including security assertion markup language (SAML), OAuth, and/or OpenID Connect (OIDC). The functions of SSO provider 108A-108N (which may be combined with identity provider 110) may allow for authentication and authorization of users, session management, and federation of services across various domains.

The identify provider 110 (or IdP) may be a separate device and/or service from SSO provider 108A-108N, or may be integrated into one or more of SSO provider 108A-108N. In some embodiments, identity provider 110 may include authentication and authorization capabilities, and may store user identities for use of one or more of SSO provider 108A-108N. In some embodiments, the user identities stored by identity provider 110 may be checked for authentication and authorization by SSO provider 108A-108N, while identity provider merely stores the identity information. The identity provider 110 and SSO provider 108A-108N may be embodied as separate devices and/or services to provide enhanced security, for example, against an attacker forging SSO credentials to provide to SSO provider 108A through SSO provider 108N.

### Example Implementing Apparatuses

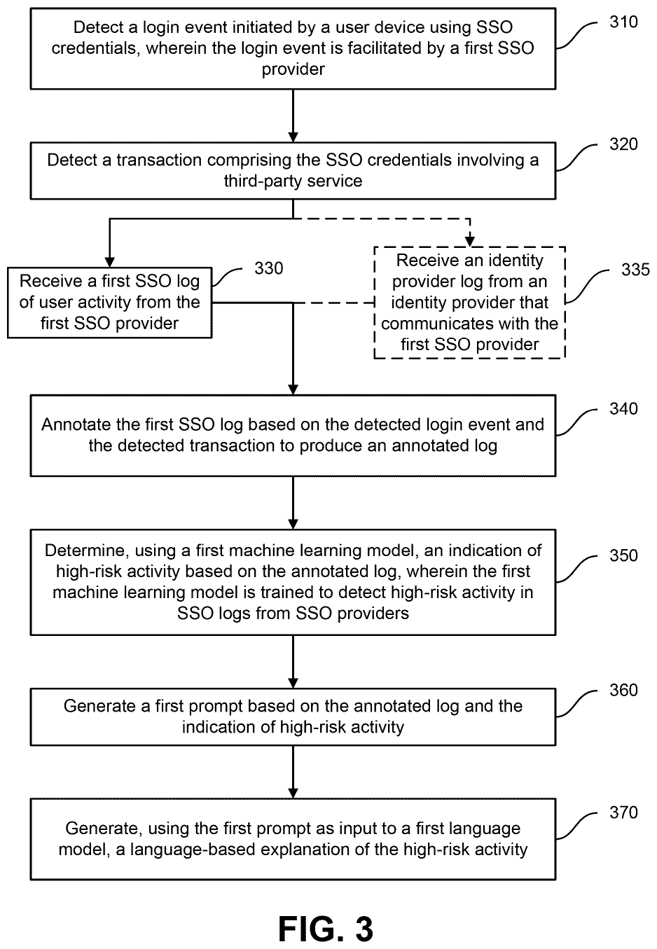

The SSO security analysis system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-5B. As illustrated in FIG. 2, the apparatus 200 may include processor 202, memory 204, communications hardware 206, SSO monitoring circuitry 208, log processing circuitry 210, machine learning circuitry 212, language model circuitry 214, licensing report circuitry 216, and security circuitry 218 each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a SSO monitoring circuitry 208 that collects telemetry related to an SSO session. The SSO monitoring circuitry 208 may utilize processor 202, memory 204, or any other hardware component included in the apparatus 200 to perform these operations, as described in connection with FIGS. 3-5B below. The SSO monitoring circuitry 208 may further utilize communications hardware 206 to gather data from a variety of sources (e.g., user device 106, shown in FIG. 1), and/or exchange data with a user, and in some embodiments may utilize processor 202 and/or memory 204 to collect SSO telemetry.

In addition, the apparatus 200 further comprises a log processing circuitry 210 that annotates and cross-correlates logs from different sources. The log processing circuitry 210 may utilize processor 202, memory 204, or any other hardware component included in the apparatus 200 to perform these operations, as described in connection with FIGS. 3-5B below. The log processing circuitry 210 may further utilize communications hardware 206 to gather data from a variety of sources (e.g., user device 106, shown in FIG. 1), and/or exchange data with a user, and in some embodiments may utilize processor 202 and/or memory 204 to annotate logs.

In addition, the apparatus 200 further comprises a machine learning circuitry 212 that determines an indication of high-risk activity from annotated logs. The machine learning circuitry 212 may utilize processor 202, memory 204, or any other hardware component included in the apparatus 200 to perform these operations, as described in connection with FIGS. 3-5B below. The machine learning circuitry 212 may further utilize communications hardware 206 to gather data from a variety of sources (e.g., user device 106, shown in FIG. 1), and/or exchange data with a user, and in some embodiments may utilize processor 202 and/or memory 204 to detect high-risk activity.

In addition, the apparatus 200 further comprises a language model circuitry 214 that generates a language-based explanation of high-risk activity. The language model circuitry 214 may utilize processor 202, memory 204, or any other hardware component included in the apparatus 200 to perform these operations, as described in connection with FIGS. 3-5B below. The language model circuitry 214 may further utilize communications hardware 206 to gather data from a variety of sources (e.g., user device 106, shown in FIG. 1), and/or exchange data with a user, and in some embodiments may utilize processor 202 and/or memory 204 to generate natural language outputs.

The apparatus 200 may further comprise a licensing report circuitry 216 that determines software usage rates from collected SSO telemetry. The licensing report circuitry 216 may utilize processor 202, memory 204, or any other hardware component included in the apparatus 200 to perform these operations, as described in connection with FIGS. 3-5B below. The licensing report circuitry 216 may further utilize communications hardware 206 to gather data from a variety of sources (e.g., user device 106, shown in FIG. 1), and/or exchange data with a user, and in some embodiments may utilize processor 202 and/or memory 204 to collect software usage data.

Finally, the apparatus 200 may further comprise a security circuitry 218 that automatically causes revocation of SSO credentials when high-risk activity is detected. The security circuitry 218 may utilize processor 202, memory 204, or any other hardware component included in the apparatus 200 to perform these operations, as described in connection with FIGS. 3-5B below. The security circuitry 218 may further utilize communications hardware 206 to gather data from a variety of sources (e.g., user device 106, shown in FIG. 1), and/or exchange data with a user, and in some embodiments may utilize processor 202 and/or memory 204 to cause revocation of SSO credentials.

Although components 202-218 are described in part using functional language, it will be understood that the particular implementations necessarily include the use of particular hardware. It should also be understood that certain of these components 202-218 may include similar or common hardware. For example, the SSO monitoring circuitry 208, log processing circuitry 210, machine learning circuitry 212, language model circuitry 214, licensing report circuitry 216, and security circuitry 218 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. While the term “circuitry” should be understood broadly to include hardware, in some embodiments, the term “circuitry” may in addition refer to software instructions that configure the hardware components of the apparatus 200 to perform the various functions described herein.

Although components 208-218 may leverage processor 202, memory 204, or communications hardware 206 as described above, it will be understood that any of components 208-218 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that components 208-218 comprise particular machinery designed for performing the functions described herein in connection with such elements of apparatus 200.

In some embodiments, various components of the apparatuses 200 may be hosted remotely (e.g., by one or more cloud servers) and thus need not physically reside on the apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatuses 200, example embodiments are described below in connection with a series of graphical user interfaces and flowcharts.

### Example Operations

Turning to FIGS. 3, 4A, 4B, 4C, 5A, and 5B, example flowcharts are illustrated that contain example operations implemented by example embodiments described herein. The operations illustrated in FIGS. 3-5B may, for example, be performed by the SSO security analysis system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, SSO monitoring circuitry 208, log processing circuitry 210, machine learning circuitry 212, language model circuitry 214, licensing report circuitry 216, security circuitry 218, and/or any combination thereof. It will be understood that user interaction with the SSO security analysis system 102 may occur directly via communications hardware 206 or may instead be facilitated by a separate user device 106, as shown in FIG. 1, and which may have similar or equivalent physical componentry facilitating such user interaction.

Turning first to FIG. 3, example operations are shown for security analysis of SSO processes. As shown by operation 310, the apparatus 200 includes means, such as processor 202, memory 204, communications hardware 206, SSO monitoring circuitry 208, or the like, for detecting a login event initiated by a user device using SSO credentials. The login event may be facilitated by a first SSO provider (e.g., one of SSO provider 108A through SSO provider 108N). In some embodiments, the communications hardware 206, operating in coordination with SSO monitoring circuitry 208, may detect the login event. The login event may occur, for example, on a user device 106 connected to a local network accessible to SSO security analysis system 102. The SSO monitoring circuitry 208 may include various telemetry software installed on user device 106, for example, to detect the SSO login event. The SSO monitoring circuitry 208 may detect the SSO login event using local, or client-facing information, in contrast to information available to SSO provider 108A through SSO provider 108N and/or identity provider 110, which may have access to privileged information on the server side. The login event may include a user entering a username and password into a login page (e.g., using user device 106), a multi-factor authentication, a biometric authentication, a token-based authentication, and/or any other form of authentication or login known in the art.

As shown by operation 320, the apparatus 200 includes means, such as communications hardware 206, SSO monitoring circuitry 208, or the like, for detecting a transaction comprising the SSO credentials involving one of SSO provider 108A through SSO provider 108N. In embodiments in which a separate identity provider 110 is used, SSO monitoring circuitry 208 may additionally or alternatively detect a transaction with identity provider 110. The SSO monitoring circuitry 208 may continue to monitor activities related to the SSO login, detected previously during operation 310. For example, the SSO monitoring circuitry 208 may include various software installed on user device 106 for telemetry that may report activities related to a SSO login to the SSO security analysis system 102. In the case that SSO monitoring circuitry 208 receives an indication that another of SSO provider 108A through SSO provider 108N (e.g., in addition to the provider involved in the initial login) is involved, the SSO monitoring circuitry 208 may record and/or report the transaction comprising the SSO credentials. For example, user device 106 may receive a session token during the SSO login detected in operation 310, and may pass a session token or a token derived from the session token to another of SSO provider 108A through SSO provider 108N (e.g., a third-party service provider). The SSO monitoring circuitry 208 may record information including the identity of third-party SP (e.g., one of SSO provider 108A through SSO provider 108N), a timestamp, information or metadata related to the data passed to another SSO provider, and/or the like.

As shown by operation 330, the apparatus 200 includes means, such as, communications hardware 206, or the like, for receiving a first SSO log of user activity from the first SSO provider (e.g., one of SSO provider 108A through SSO provider 108N). In some embodiments, the communications hardware 206 may receive an external log of user activity from the first SSO provider. The SSO log of user activity may include server-side information reported by the first SSO provider.

As shown by operation 335, the apparatus 200 may include means, such as communications hardware 206, or the like, for receiving an identity provider log from an identity provider (e.g., identity provider 110) that communicates with the first SSO provider (e.g., one of SSO provider 108A through SSO provider 108N). In some embodiments, the communications hardware 206 may receive an external identity provider log from identity provider 110. The identity provider log may include server-side information reported by the identity provider 110. The information provided in the first SSO log of user activity and/or the identity provider log may include reports of events that correspond to events recorded by SSO monitoring circuitry 208 in addition to logged events available only to the server-side logging.

As shown by operation 340, the apparatus 200 includes means, such as processor 202, memory 204, log processing circuitry 210, or the like, for annotating the first SSO log based on the detected login event and the detected transaction to produce an annotated log. In some embodiments, annotating the first SSO log may be further based on the SSO log of user activity (e.g., from SSO provider 108A), an identity provider log (e.g., from identity provider 110) and/or a combination of the above. In some embodiments, the log processing circuitry 210 may annotate the identity provider log to produce the annotated log.

The log processing circuitry 210 may retrieve log information from, for example, operation 320, operation 330, and/or operation 335, from memory 204, and analyze the logs to produce annotations and produce the annotated log. For example, log processing circuitry 210 may detect synchronous events in the analyzed logs, such as a login event detected both by the SSO monitoring circuitry 208 and the SSO log retrieved from SSO provider 108A. In another example, the log processing circuitry 210 may annotate a first log during an outage of a logging service producing the first log using events from the second log. Log processing circuitry 210 may additionally or alternatively check for conflicts between logs. In some embodiments, a conflict detected when comparing logs may result in a report of high-risk activity or produce an alert to an administrator of SSO security analysis system 102.

The use of the resulting annotated log may increase the confidence of any conclusions drawn from the annotated log compared to conclusions based on individual logs. The annotated log may use any format available, for example, using the same format as the base SSO log or a distinct format not shared with the SSO log. In some embodiments, information from the SSO log may be processed, truncated, filtered, cleaned, or otherwise modified to generate the annotated log.

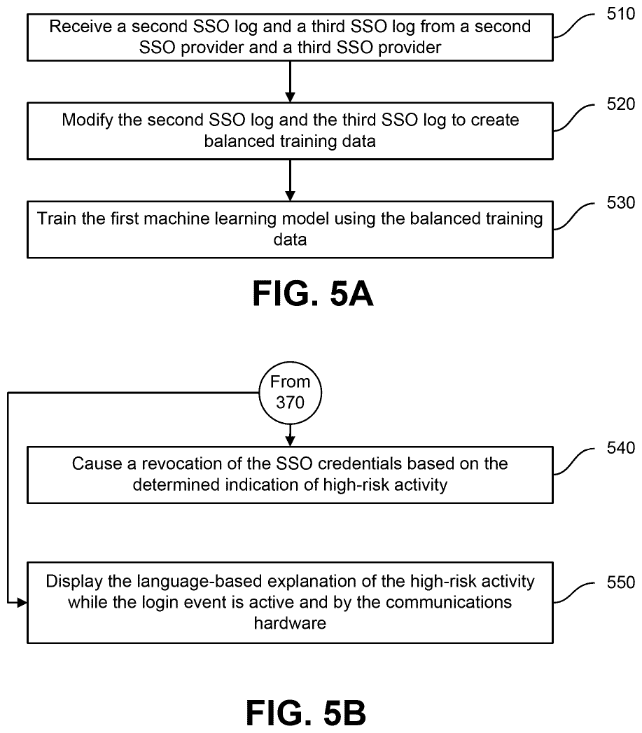

As shown by operation 350, the apparatus 200 includes means, such as processor 202, memory 204, machine learning circuitry 212, or the like, for determining, using a first machine learning model, an indication of high-risk activity based on the annotated log. The first machine learning model may be trained to detect high-risk activity in SSO logs from one of SSO provider 108A through SSO provider 108N. The machine learning circuitry 212 may utilize a first machine learning model (which may be trained, for example, as described below in connection with FIG. 5A). The first machine learning model may be any machine learning and/or artificial intelligence model known in the art, including neural networks, decision trees, support vector machines, transformers, various types or variations of neural networks including deep neural networks, autoencoders, convolutional neural networks, recurrent neural networks, and/or the like. The first machine learning model may be trained and configured to identify high-risk activity based on an annotated log. For example, the first machine learning model may output a score indicating the degree of confidence that an annotated log or a section of an annotated log includes high-risk activity.

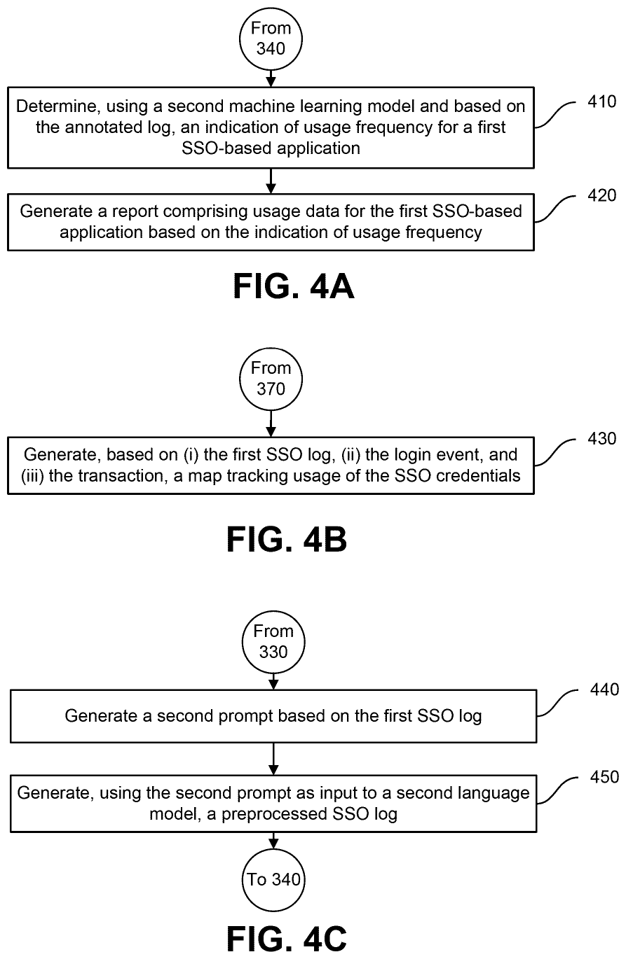

In some embodiments, the machine learning model may include components, layers, or sub-models dedicated to interpreting natural language that may process the log file to produce an intermediate data form and/or connect directly subsequent layers or components of the first machine learning model. For example, FIG. 4C below describes an example method for using a language model for pre-processing the annotated log.

Additionally or alternatively, the annotated log file may be processed using a rules-based preprocessor. For example, a timestamp for each line of a log may be converted to an integer time value, and each log event may be converted to a vector encoding the type of log event. In some embodiments, embedding may be performed using an embedding model to prepare a lower-dimensional space representing the various types of log events. In an example using embedding, a log event related to entering an incorrect username may be “closer” in vector space to an event related to an incorrect password, while an event related to an unrelated topic, such as an informational message about network conditions, may be more “distant” than the first to example events. Accordingly, the preprocessed log generated by a rules-based approach may be a time series of vector objects, where each vector object may represent a distinct type of log entry.

As shown by operation 360, the apparatus 200 includes means, such as processor 202, memory 204, language model circuitry 214, or the like, for generating a first prompt based on the annotated log and the indication of high-risk activity. In some embodiments, the language model circuitry 214 may use the annotated log and the indication of high-risk activity to generate a language prompt that instructs the first language model to create an explanation of the high-risk activity based on the annotated prompt. In some examples, the machine learning circuitry 212 and/or the first machine learning model may provide an indication of a location in the annotated log that points out the log entry corresponding to the high-risk activity. In some examples, the first language model may be trained and/or fine-tuned to determine the explanation without a precise location of the high-risk activity. The first prompt may include the instructions to provide the explanation for the high-risk activity, and may further include the annotated log, other outputs of the first machine learning model (e.g., retrieved from storage such as memory 204), and/or the like.

As shown by operation 370, the apparatus 200 includes means, such as processor 202, memory 204, language model circuitry 214, or the like, for generating, using the first prompt as input to a first language model, a language-based explanation of the high-risk activity. The first language model may be any machine learning/artificial intelligence model known in the art that is able to process and generate language-based data. For example, the first language model may be a transformer or any other approach based on attention mechanisms, recurrent neural network, neural network using long short-term memory, convolutional neural network, Markov model, or any combination or variation thereof. The first language model may be trained like a typical language model to understand general language input and output, or may use specialized training for understanding log files (e.g., the annotated log file). In any case, the first language model may include training or fine-tuning to process log files related to SSO security and detect high-risk activity and anomalous behavior.

The language model circuitry 214 may provide the first prompt to the first language model via an application programming interface or other means. The first language model may generate the output providing the language-based explanation of the high-risk activity. For example, the explanation may include an excerpt of the annotated log and an indication of the log entry accompanied by an explanation of why the log entry indicates high-risk activity. The high-risk activity may be any activity that indicates an elevated security threat. For example, activity that may lead to an increased risk of an attacker gaining access to login credentials from a user by exploiting various activities performed in the SSO login session may indicate high-risk activity.

Turning now to FIG. 4A, example operations are shown for optimizing licensed software usage. As shown by operation 410, the apparatus 200 includes means, such as processor 202, memory 204, machine learning circuitry 212, or the like, for determining, using a second machine learning model and based on the annotated log, an indication of usage frequency for a first SSO-based application. The second machine learning model may be trained to detect usage frequency for SSO-based applications. For example, the machine learning circuitry 212 may train the second machine learning model as a separate machine learning model, or the machine learning circuitry 212 may use transfer learning or fine tuning to modify the first machine learning model to produce the second machine learning model. In some embodiments, the second machine learning model may be a generative model and/or include components or layers for generating usage statistics for various SSO applications. In some embodiments, the second machine learning model may prepare or format the annotated log to provide data to a rules-based engine that prepares the usage statistics based on data prepared by the second machine learning model. For example, the second machine learning model may analyze data sent to and received from various instances of SSO provider 108A through SSO provider 108N and other service providers to determine the identity of one or more third party applications, services, or other SSO-based applications.

As shown by operation 420, the apparatus 200 includes means, such as processor 202, memory 204, licensing report circuitry 216, or the like, for generating a report comprising usage data for the first SSO-based application based on the indication of usage frequency. The licensing report circuitry 216 may analyze results produced by the second machine learning model to determine information for reporting related to usage data for a first SSO-based application. The licensing report circuitry 216 may include in the report data on additional SSO-based applications. Additionally, the report may include various recommendations based on usage patterns detected in an organization. The licensing report circuitry 216 may also have access to records of licensing information for an organization (e.g., stored in memory 204) for use in the report, such as the number and type of licenses for various SSO-based applications. For example, the licensing report circuitry 216 may report that an organization is paying for a software license that is being rarely used or underutilized, and may recommend reducing the tier or payment level for the license. The licensing report circuitry 216 may use a rules-based approach, or may employ various machine learning/artificial intelligence models to prepare the recommendations based on the usage reports from the second machine learning model. The report may be viewable using any methods known in the art, for example, as a webpage, document file, or the like.

Turning now to FIG. 4B, example operations are shown for generating an SSO usage map. As shown by operation 430, the apparatus 200 includes means, such as processor 202, memory 204, log processing circuitry 210, or the like, for generating, based on the (i) first SSO log, (ii) the login event, and (iii) the transaction (e.g., the transaction comprising SSO credentials), a map tracking usage of the SSO credentials. The indication of high-risk activity may be determined based on the map. The map may take the form of a directed graph with edges indicating transfer of information and nodes indicating devices involved in the SSO session. In some examples, the map may take the form of a knowledge graph, which stores information in subject-verb-object entries. For example, the knowledge graph may include an entry indicating that a user device 106 sent login information to SSO provider 108A, and another entry indicating that SSO provider 108A requested verification of identity information from identity provider 110. In some embodiments, the first machine learning model may be trained to analyze the map (e.g., a knowledge graph or another directed graph) to detect high-risk activity in the SSO session.

Turning now to FIG. 4C, example operations are shown for generating a preprocessed SSO log. As shown by operation 440, the apparatus 200 includes means, such as processor 202, memory 204, language model circuitry 214, or the like, for generating a second prompt based on the first SSO log. As discussed previously, the language model circuitry 214 may prepare a preprocessed log, which may in turn be processed by the first machine learning model to detect an instance of high-risk activity related to the SSO login. For example, the second prompt may include the first SSO log and instructions that cause the second language model to generate a preprocessed law. The instructions, for example, may indicate that the second language model should be reformatted to preserve the information in the first SSO log while using a preferred formatting. In some embodiments, the second prompt may include an example of the preferred formatting. In some embodiments, the second prompt may be prepared to change the formatting of a log with unknown formatting to match the formatting of another existing log that interfaces with the first machine learning model and/or other components or models of the apparatus 200.

As shown by operation 450, the apparatus 200 includes means, such as processor 202, memory 204, language model circuitry 214, or the like, for generating, using the second prompt as input to a second language model, a preprocessed SSO log. The first SSO log may use a first formatting and the preprocessed SSO log may use a second formatting. As discussed previously, the language model circuitry 214 may configure the second language model to modify the formatting of the first SSO log while preserving the contents of the first SSO log. The preprocessed SSO log may receive further processing, annotating, or other modifications in addition to the preprocessing of the second language model.

Turning now to FIG. 5A, example operations are shown for training a machine learning model on disparate log data. As shown by operation 510, the apparatus 200 includes means, such as communications hardware 206, or the like, for receiving a second SSO log from a second SSO provider and/or a third SSO log from a third SSO provider. The annotated log may be based on the second SSO log. For example, the first SSO log may be received, as described in connection with operation 330, from SSO provider 108A, while the second SSO log may be received from SSO provider 108B and the third SSO log may be received from SSO provider 108C.

As shown by operation 520, the apparatus 200 includes means, such as processor 202, memory 204, machine learning circuitry 212, or the like, for modifying the second SSO log and the third SSO log to create balanced training data. The machine learning circuitry 212 may modify the second SSO log and third SSO log using any technique known in the art to create balanced training data samples. For example, the logs may be oversampled and/or undersampled to create balanced training data. In another example, the smaller log may be augmented using various transformations to the log data to increase the size of the log. In another example, the balanced training data may not include modifications to the logs themselves, but the loss function may include weighting to balance the training data, or transfer learning may be used to train on a larger log and a smaller log in subsequent stages. It will be understood that

As shown by operation 530, the apparatus 200 includes means, such as processor 202, memory 204, machine learning circuitry 212, or the like, for training the first machine learning model using the balanced training data. The first machine learning model may be trained using any training techniques known in the art, which may depend on the type of model employed by the first machine learning model. For example, machine learning circuitry 212 may use supervised, unsupervised, or semi-supervised learning to train the first machine learning model. Accordingly, machine learning circuitry 212 may prepare, clean, format, or make other modifications to a second SSO log, third SSO log, annotated log, and/or a preprocessed log to prepare training data. For example, the training data may be sampled from the logs to reduce overtraining, to reserve training data to test against overtraining, and/or the like. Various embeddings and/or pre-processing may occur as described above in connection with operation 350. After training, the first machine learning model may be prepared to identify examples of high-risk activity in the first SSO log.

Finally, turning now to FIG. 5B, example operations are shown for taking action based on a finding of high-risk SSO activity. As shown by operation 540, the apparatus 200 includes means, such as processor 202, memory 204, communications hardware 206, security circuitry 218, or the like, for causing a revocation of the SSO credentials based on the determined indication of high-risk activity. The security circuitry 218 may, in conjunction with the communications hardware 206 and/or other circuitry, issue a command or otherwise cause revocation of the SSO credentials automatically upon detection of high-risk activity. For example, security circuitry 218 may issue a command via an application programming interface that causes a credentialed server or other device (e.g., SSO provider 108A) to revoke the SSO credentials, effectively ending the SSO login session and disconnecting any services such as additional SPs including SSO provider 108A through SSO provider 108N. In some examples, the security circuitry 218 may cause a temporary hold on the account associated with the high-risk activity, preventing a would-be attacker from re-authenticating and attempting the high-risk activity again.

As shown by operation 550, the apparatus 200 includes means, such as communications hardware 206, or the like, for displaying, while the login event is active the language-based explanation of the high-risk activity. The communications hardware 206 may display or cause the display, for example, by user device 106, of the language-based explanation of the high-risk activity. For example, the user and/or a system administrator may receive the message with the explanation of the high-risk activity. The message may be displayed using any method known in the art, for example, a push notification on a mobile device, an email message, and/or the like.

### Conclusion

As described above, example embodiments provide methods and apparatuses that enable security analysis of SSO processes. By cross-checking across multiple logging sources and leveraging ML to analyze annotated logs, example embodiments improve real-time detection of security threats arising from SSO sessions. While SSO offers enhanced convenience and centralized security for administrators and users, the sharing of SSO credentials to multiple SPs may create security risks. By providing advanced systems and methods for analyzing the pathway of SSO tokens and other information in an SSO process, the security and functionality of networked computers that employ SSO can be improved.

As these examples all illustrate, example embodiments contemplated herein provide technical solutions that solve real-world problems faced in the field of network security. While SSO alone provides several security advantages over traditional methods, techniques to further improve security in organizations making heavy use of SSO are still needed. Example embodiments disclosed herein leverage multiple sources of data to quickly and effectively identify potential threats using SSO, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for security analysis of a single sign-on (SSO) process, the method comprising:
detecting, by SSO monitoring circuitry, a login event initiated by a user device using SSO credentials, wherein the login event is facilitated by a first SSO provider;
detecting, by the SSO monitoring circuitry, a transaction comprising the SSO credentials involving a third-party service;
receiving, by communications hardware, a first SSO log of user activity from the first SSO provider;
annotating, by log processing circuitry, the first SSO log based on the detected login event and the detected transaction to produce an annotated log;
determining, by machine learning circuitry and using a first machine learning model, an indication of high-risk activity based on the annotated log, wherein the first machine learning model is trained to detect high-risk activity in SSO logs from SSO providers;
generating, by language model circuitry, a first prompt based on the annotated log and the indication of high-risk activity; and
generating, by the language model circuitry and using the first prompt as input to a first language model, a language-based explanation of the high-risk activity.

2. The method of claim 1, further comprising:
determining, by the machine learning circuitry and using a second machine learning model and based on the annotated log, an indication of usage frequency for a first SSO-based application, wherein the second machine learning model is trained to detect usage frequency for SSO-based applications; and
generating, by licensing report circuitry, a report comprising usage data for the first SSO-based application based on the indication of usage frequency.

3. The method of claim 1, further comprising:
receiving, by the communications hardware, an identity provider log from an identity provider that communicates with the first SSO provider, wherein the annotating the first SSO log is further based on the identity provider log.

4. The method of claim 1, further comprising:
generating, by the log processing circuitry and based on the (i) first SSO log, (ii) the login event, and (iii) the transaction, a map tracking usage of the SSO credentials, wherein the indication of high-risk activity is determined based on the map.

5. The method of claim 1, further comprising:
generating, by the language model circuitry, a second prompt based on the first SSO log; and
generating, by the language model circuitry and using the second prompt as input to a second language model, a preprocessed SSO log, wherein the first SSO log uses a first formatting and the preprocessed SSO log uses a second formatting.

6. The method of claim 1, further comprising:
receiving, by the communications hardware, a second SSO log from a second SSO provider, wherein the annotated log is based on the second SSO log; and
training, by the machine learning circuitry, the first machine learning model using the second SSO log.

7. The method of claim 6, further comprising:
receiving, by the communications hardware, a third SSO log from a third SSO provider, wherein the annotated log is based on the second SSO log;
modifying, by the machine learning circuitry, the second SSO log and the third SSO log to create balanced training data; and
training, by the machine learning circuitry, the first machine learning model using the balanced training data.

8. The method of claim 1, further comprising:
causing, by security circuitry, a revocation of the SSO credentials based on the determined indication of high-risk activity.

9. The method of claim 1, further comprising:
displaying, while the login event is active and by the communications hardware, the language-based explanation of the high-risk activity.

10. An apparatus for security analysis of a single sign-on (SSO) process, the apparatus comprising:
SSO monitoring circuitry configured to:
detect a login event initiated by a user device using SSO credentials, wherein the login event is facilitated by a first SSO provider, and
detect a transaction comprising the SSO credentials involving a third-party service;
communications hardware configured to:
receive a first SSO log of user activity from the first SSO provider;
log processing circuitry configured to:
annotate the first SSO log based on the detected login event and the detected transaction to produce an annotated log;
machine learning circuitry configured to:
determine, using a first machine learning model, an indication of high-risk activity based on the annotated log, wherein the first machine learning model is trained to detect high-risk activity in SSO logs from SSO providers, and
generate a first prompt based on the annotated log and the indication of high-risk activity; and
language model circuitry configured to:
generate, using the first prompt as input to a first language model, a language-based explanation of the high-risk activity.

11. The apparatus of claim 10, wherein the machine learning circuitry is further configured to:
determine, using a second machine learning model and based on the annotated log, an indication of usage frequency for a first SSO-based application, wherein the second machine learning model is trained to detect usage frequency for SSO-based applications, wherein the apparatus further comprises licensing report circuitry configured to:
generate a report comprising usage data for the first SSO-based application based on the indication of usage frequency.

12. The apparatus of claim 10, wherein the communications hardware is further configured to:
receive an identity provider log from an identity provider that communicates with the first SSO provider, wherein the annotating the first SSO log is further based on the identity provider log.

13. The apparatus of claim 10, wherein the log processing circuitry is further configured to:
generating, by the log processing circuitry and based on the (i) first SSO log, (ii) the login event, and (iii) the transaction, a map tracking usage of the SSO credentials, wherein the indication of high-risk activity is determined based on the map.

14. The apparatus of claim 10, wherein the language model circuitry is further configured to:
generate a second prompt based on the first SSO log; and
generate, using the second prompt as input to a second language model, a preprocessed SSO log, wherein the first SSO log uses a first formatting and the preprocessed SSO log uses a second formatting.

15. The apparatus of claim 10, wherein the communications hardware is further configured to:
receiving, by the communications hardware, a second SSO log from a second SSO provider, wherein the annotated log is based on the second SSO log,
wherein the machine learning circuitry is further configured to train the first machine learning model using the second SSO log.

16. The apparatus of claim 15, wherein the communications hardware is further configured to:
receive a third SSO log from a third SSO provider, wherein the annotated log is based on the second SSO log,
wherein the machine learning circuitry is further configured to:
modify the second SSO log and the third SSO log to create balanced training data; and
train the first machine learning model using the balanced training data.

17. The apparatus of claim 10, further comprising security circuitry configured to:
cause a revocation of the SSO credentials based on the determined indication of high-risk activity.

18. The apparatus of claim 10, wherein the communications hardware is further configured to:
display, while the login event is active and by the communications hardware, the language-based explanation of the high-risk activity.

19. A computer program product for security analysis of a single sign-on (SSO) process, the computer program product comprising at least one non-transitory computer-readable storage medium storing program instructions that, when executed, cause a system to:
detect a login event initiated by a user device using SSO credentials, wherein the login event is facilitated by a first SSO provider;
detect a transaction comprising the SSO credentials involving a third-party service;
receive a first SSO log of user activity from the first SSO provider;
annotate the first SSO log based on the detected login event and the detected transaction to produce an annotated log;
determine, using a first machine learning model, an indication of high-risk activity based on the annotated log, wherein the first machine learning model is trained to detect high-risk activity in SSO logs from SSO providers;
generate a first prompt based on the annotated log and the indication of high-risk activity; and
generate, using the first prompt as input to a first language model, a language-based explanation of the high-risk activity.

20. The computer program product of claim 19, further comprising additional program instructions that, when executed, cause the system to:
determine, using a second machine learning model and based on the annotated log, an indication of usage frequency for a first SSO-based application, wherein the second machine learning model is trained to detect usage frequency for SSO-based applications; and
generate a report comprising usage data for the first SSO-based application based on the indication of usage frequency.
